(19) United States
(12) Patent Application Publication
(10) Pub. No.: US 2011/0250792 A1
(43) Pub. Date: Oct. 13, 2011

(54) BACKSHELL FOR A CONNECTOR ASSEMBLY

(75) Inventors: ROBERT NEIL WHITEMAN, JR., MIDDLETOWN, PA (US); CHRISTOPHER DAVID RITTER, HUMMELSTOWN, PA (US)

(73) Assignee: TYCO ELECTRONICS CORPORATION, BERWYN, PA (US)

(21) Appl. No.: 12/758,102

(22) Filed: Apr. 12, 2010

(51) Int. Cl. H01R 13/648

(52) U.S. Cl. 439/607.19

(57) ABSTRACT

A connector assembly includes a connector having a connector housing holding contacts, with the contacts being configured to be terminated to cables extending rearward from the connector housing. The connector assembly also includes a backshell having walls defining a cavity receiving the connector housing and cables. The backshell is electrically connected to cable shields of the cables. The backshell has fingers extending from the walls that are configured to engage a grounded component exterior of the cavity. Distal ends of the fingers are captured interior of the cavity.

### BACKGROUND OF THE INVENTION

The subject matter herein relates generally to connector assemblies, and more particularly, to a backshell for a connector assembly.

With the ongoing trend toward smaller, faster, and higher performance electrical components such as processors used in computers, routers, switches, etc., it has become increasingly desirable for the electrical interfaces along the electrical paths to also operate at higher frequencies and at higher densities with increased throughput. For example, performance demands for video, voice and data drive input and output speeds of connectors within such systems to increasingly faster levels.

An electrical interconnection between devices is typically made by joining together complementary electrical connectors that are attached to the devices. One application environment that uses such electrical connectors is in high speed, differential electrical systems, such as those common in the telecommunications or computing environments. In a traditional approach, two circuit boards are interconnected with one another in a backplane and a daughter board configuration. However, similar types of connectors are also being used in cable connector to board connector applications. With the cable connector to board configuration, one connector, commonly referred to as a header, is board mounted and includes a plurality of signal contacts which connect to conductive traces on the board. The other connector, commonly referred to as a cable connector or a receptacle, includes a plurality of contacts that are connected to individual wires in one or more cables of a cable assembly. The receptacle mates with the header to interconnect the board with the cables so that signals can be routed therebetween.

However, because of the environments that such electrical connectors are used in, the electrical connectors may generate and/or be subjected to various levels of electromagnetic interference (EMI) or radiofrequency interference (RFI) emitted from external sources, such as electronic devices in the vicinity of the electrical connectors. The EMI and/or RFI may interrupt, obstruct, or otherwise degrade or limit the effective performance of the electrical connectors or other electronic devices in the vicinity of the electrical connectors. Typically the electrical connectors include a backshell that provides shielding from EMI and/or RFI and/or prevent EMI and/or RFI from being emitted from within the enclosure of the backshell. The backshell is a metal part that surrounds the cables and is electrically connected to the cable shield of the cables to provide shielding around the cables and the interface of the cables to the contacts of the electrical connectors. Systems using backshells are not without disadvantages. For example, the backshells typically include fingers that are biased against the cable shield or another shield element that engages the cable shield at multiple contact points. To provide effective shielding the contact points are closely spaced as dictated by the frequencies being contained. Also design considerations are made to avoid creating a structure that would allow ground currents to create voltages that would effectively create an emitting antenna. The fingers are susceptible to damage. For example, the fingers are cantilevered and the free ends of the fingers may snag or stub on other components and/or the cables, such as during handling, shipping, installation, and the like. The fingers are thin to allow close spacing, which makes the fingers susceptible to damage.

A need remains for a connector assembly that has a reduced risk of damage. A need remains for a backshell having fingers that are protected from snagging and/or stubbing.

### BRIEF DESCRIPTION OF THE INVENTION

In one embodiment, a connector assembly is provided that includes a connector having a connector housing holding contacts, with the contacts being configured to be terminated to cables extending rearward from the connector housing. The connector assembly also includes a backshell having walls defining a cavity receiving the connector housing and cables. The backshell is electrically connected to cable shields of the cables. The backshell has fingers extending from the walls that are configured to engage a grounded component exterior of the cavity. Distal ends of the fingers are captured interior of the cavity.

In another embodiment, a connector assembly is provided including a connector having a connector housing holding contacts, with the contacts being configured to be terminated to cables extending rearward from the connector housing. The connector assembly also includes a backshell having walls defining a cavity receiving the connector housing and cables. The backshell is electrically connected to cable shields of the cables. At least one of the walls has fingers extending therefrom and slots aligned with the fingers. The fingers are configured to engage a grounded component exterior of the cavity, and the fingers have tabs proximate to distal ends of the fingers. The tabs are loaded through the slots and are captured by the corresponding wall interior of the cavity.

In a further embodiment, a backshell is provided for a connector assembly that includes walls defining a cavity configured to receive a cable, with the walls being configured to be electrically connected to a cable shield of the cable. The backshell also includes fingers being cantilevered from at least one of the walls, with the fingers being configured to engage a grounded component exterior of the cavity. Distal ends of the fingers are captured by the corresponding wall interior of the cavity.

### BRIEF DESCRIPTION OF THE DRAWINGS

FIG. 1 is a rear perspective view of a connector assembly formed in accordance with an exemplary embodiment.

FIG. 2 is a perspective view of an exemplary contact module for the connector assembly shown in FIG. 1.

FIG. 3 schematically illustrates an internal structure, including a leadframe, of the contact module shown in FIG. 2.

FIG. 4 is a rear perspective view of a cable connector for the connector assembly shown in FIG. 1.

FIG. 5 illustrates a portion of a backshell formed in accordance with an exemplary embodiment and usable with the connector assembly shown in FIG. 1.

FIG. 6 is a bottom perspective view of a portion of the backshell shown in FIG. 5.

FIG. 7 is a top perspective view of a portion of the backshell shown in FIG. 5.

### DETAILED DESCRIPTION OF THE INVENTION

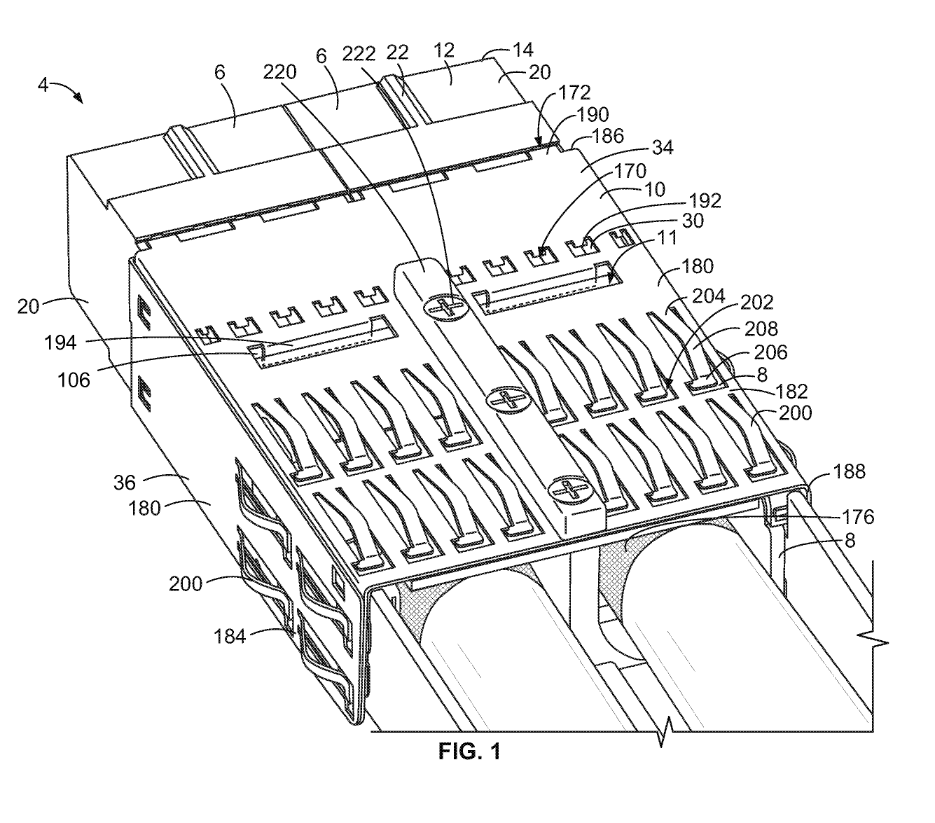

FIG. 1 is a rear perspective view of a connector assembly 4 formed in accordance with an exemplary embodiment. The connector assembly 4 represents a receptacle connector assembly and may be referred to hereinafter as receptacle connector assembly 4. The receptacle connector assembly 4 is matable with a header connector assembly (not shown) to create a differential connector system. For example, the header connector assembly may be a Z-PACK TinMan header connector, which is commercially available from Tyco Electronics. While the receptacle connector assembly 4 will be described with particular reference to high speed, differential cable connectors, it is to be understood that the benefits herein described are also applicable to other connectors in alternative embodiments. The following description is therefore provided for purposes of illustration, rather than limitation, and is but one potential application of the subject matter herein.

As illustrated in FIG. 1, the receptacle connector assembly 4 includes a pair of cable connectors 6 and a cable exit plate 8 held together by a backshell 10. The cable connectors 6 are arranged in a stacked configuration side-by-side. The cable connectors 6 may be stacked horizontally or vertically. Any number of cable connectors 6 may be provided within the connector assembly 4 and held by the backshell 10. In an alternative embodiment, only one cable connector 6 is provided and held by the backshell 10.

The cable exit plate 8 is provided rearward of the cable connectors 6. The cable exit plate 8 holds cables that extend from the cable connectors 6 and provides strain relief for the cables. The cable exit plate 8 engages and is electrically connected to a cable braid or cable shield (not shown) of the cables to electrically common the cable exit plate 8 and the cable shields. Multiple cable exit plates 8 may be used, such as one for each cable connector 6.

The backshell 10 physically holds the cable connectors 6 and cable exit plate 8 together. The backshell 10 is manufactured from a metal material and forms a cavity 11 that receives the cable exit plate 8 and the cable connectors 6. The cable exit plate 8 may have an outer periphery that substantially fills the cavity 11 such that the cable exit plate 8 is in close proximity to the backshell 10. As such, the backshell 10 can engage the cable exit plate 8 to electrically common the backshell 10 and the cable exit plate 8. The backshell 10 provides shielding for the cable connectors 6 as well as the associated cables. The backshell 10 extends entirely around the cable exit plate 8 and the cable connectors 6 to provide circumferential shielding from electrical interference, such as electromagnetic interference (EMI), radiofrequency interference (RFI), and the like.

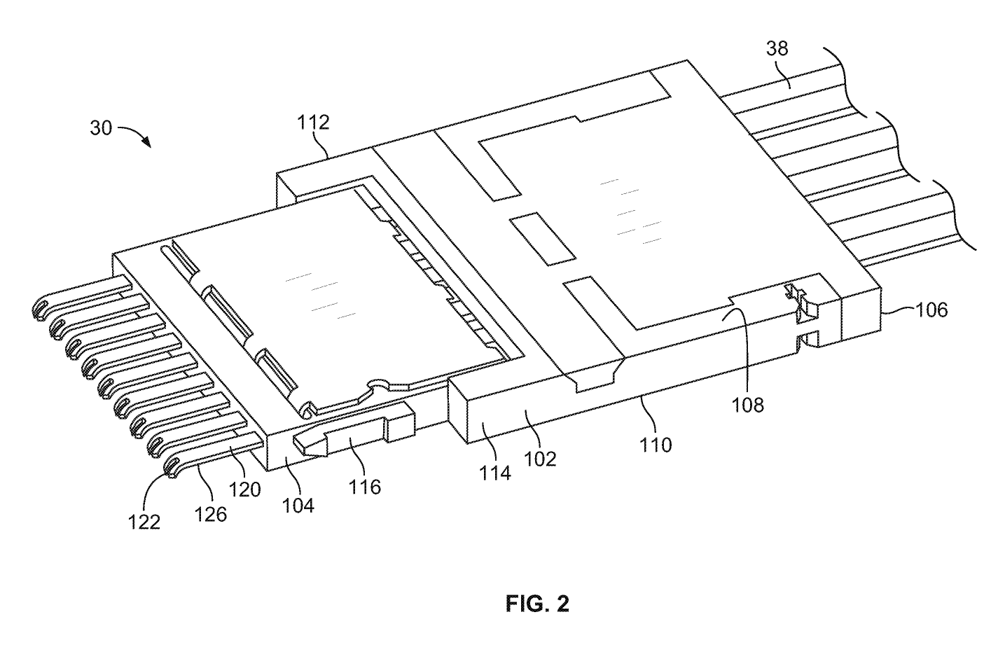

Each cable connector 6 includes a dielectric housing 12 having a front 14 that defines a mating interface for mating with the header connector assembly. The front 14 defines a forward mating end. The housing 12 holds contacts 120 (shown in FIG. 2) and is configured to receive corresponding mating contacts (not shown) from the header connector assembly for mating with the contacts 120. The housing 12 includes a plurality of support walls 20. Alignment ribs 22 are provided for guided mating with the header connector assembly.

A plurality of contact modules 30 (shown in FIG. 2) are received in each housing 12. The backshell 10 may be used to securely couple the contact modules 30 to the housing 12, as will be described in further detail below.

In an exemplary embodiment, the backshell 10 has two hermaphroditic shell halves that are coupled together to form the backshell 10. The shell halves are coupled together around the cable connectors 6, such as from above and below the cable connectors 6. In an exemplary embodiment, the backshell 10 includes an upper shell 34 and a lower shell 36 that are separate and distinct from one another. The upper and lower shells 34, 36 are coupled together such that the upper and lower shells 34, 36 peripherally surround the housings 12, contact modules 30 of the cable connectors 6 and the cables extending from the contact modules 30. The upper and lower shells 34, 36 are coupled to the housings 12 and to the contact modules 30 to maintain the relative positions of the contact modules 30 with respect to the housing 12. In an exemplary embodiment, the upper and lower shells 34, 36 are substantially identically formed. For example, the upper and lower shells 34, 36 may be manufactured as the same part in an assembly line. In an exemplary embodiment, the upper and lower shells 34, 36 are stamped and formed from a blank of metal material. During assembly, the lower shell 36 is inverted with respect to the upper shell 34 and coupled thereto.

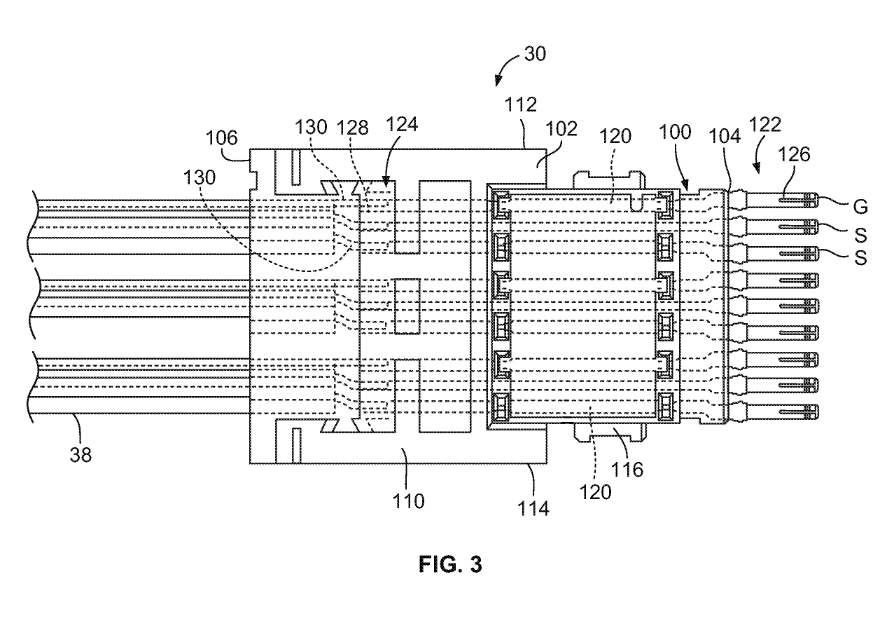

FIG. 2 is a perspective view of one of the contact modules 30 that is matable with the housing 12 (shown in FIG. 1) to form the cable connector 6 (shown in FIG. 1). FIG. 3 illustrates an internal structure, including an internal lead frame 100, of the contact module 30 in phantom. The contact module 30 includes a dielectric body 102 that surrounds the lead frame 100. In some embodiments, the body 102 is manufactured using an overmolding process. During the overmolding process, the lead frame 100 is encased in a dielectric material, such as a plastic material, which forms the body 102. Optionally, the contact module 30 may be manufactured in stages that include more than one overmolding process (e.g. an initial overmolding and a final overmolding). The body 102 may be manufactured using forming processes other than overmolding. For example, rather than being overmolded, the body may be manufactured in one or more components that are coupled together around the lead frame 100 or that receive individual contacts rather than a lead frame 100.

As illustrated in FIG. 2, the body 102 extends between a forward mating end 104 and a rear end 106. Cables 38 extend rearward from the rear end 106. The body 102 includes opposed first and second generally planar side surfaces 108 and 110, respectively. The side surfaces 108 and 110 extend substantially parallel to, and along, the lead frame 100. The body 102 includes opposed top and bottom ends 112, 114. Optionally, ribs 116 may be provided on each of the top and bottom ends 112, 114. The ribs 116 may be used to guide and/or orient the contact modules 30 into and/or within the housing 12.

As illustrated in FIG. 3, the lead frame 100 includes a plurality of contacts 120 that extend between mating ends 122 and wire terminating ends 124. Mating contact portions 126 are provided at the mating ends 122, and the mating contact portions 126 are configured to be loaded into contact cavities (not shown) of the housing 12 for mating with corresponding mating contacts of the header connector assembly (not shown). The contacts 120 define wire mating portions proximate to the wire terminating ends 124. For example, the contacts 120 may include solder pads 128 at the wire terminating ends 124 for terminating to respective wires 130 of the cable 38 by soldering. Other terminating processes and/or features may be provided at the wire terminating ends 124 for terminating the wires 130 to the contacts 120. For example, insulation displacement contacts, wire crimp contacts, and the like may be provided at the wire terminating ends 124. The mating contact portions 126 and/or the solder pads 128 may be formed integrally with the contacts 120, such as by a stamping and/or forming process, or the mating contact portions 126 and/or the solder pads 128 may be separately provided and electrically connected to the contacts 120.

In an exemplary embodiment, the contacts 120 are arranged generally parallel to one another between the mating ends 122 and wire terminating ends 124. The mating ends 122 and the wire terminating ends 124 are provided at generally opposite ends of the contact module 30. However, other configurations are possible in alternative embodiments, including right angle contacts 120 or other types of contacts.

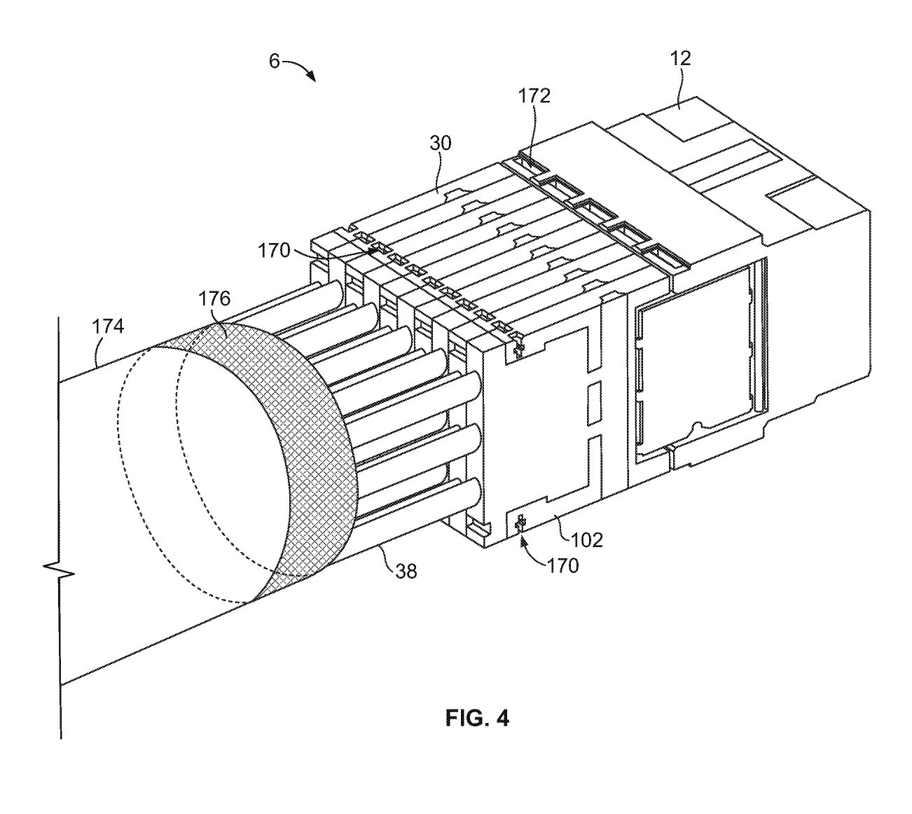

FIG. 4 is a rear perspective view of the cable connector 6 in a partially assembled state, with the contact modules 30 plugged into the housing 12. Optionally, the contact modules 30 may be resiliently retained within discrete chambers of the housing, such as by a friction fit and/or with barbs on the contact portions 126 (shown in FIG. 3).

In an exemplary embodiment, grooves 170 are provided in the bodies 102 of the contact modules 30 for receiving portions of the upper and lower shells 34, 36 (shown in FIG. 1). In an exemplary embodiment, grooves 172 are also provided in the housing 12. The upper and lower shells 34, 36 include features that engage the grooves 170, 172 to hold the contact modules 30 within the housing 12. Also, by engaging the grooves 170, the upper and lower shells 34, 36 may prevent adjacent contact modules 30 from spreading apart from one another, in essence locking each of the contact modules 30 together, to provide rigidity to the contact modules 30.

The individual cables 38 extend rearward from the contact modules 30, and may be bundled together into a larger cable 174. The cable 174 includes a cable shield 176 surrounding the bundled cables 38. The cable shield 176 is electrically connected to the upper and lower shells 34, 36 when the receptacle connector assembly 4 is assembled.

Returning to FIG. 1, the upper and lower shells 34, 36 cooperate to form the backshell 10, which is mechanically connected to the housings 12, contact modules 30 and cable exit plate 8. The backshell 10 is also electrically connected to the cable shield 176, such as by the mechanical engagement with the cable exit plate 8, which directly engages the cable shield 176.

The backshell 10 includes a plurality of walls 180, represented in the illustrated embodiment by end walls 182 and side walls 184. The end walls 182 and side walls 184 may be perpendicular to one another defining a parallelepiped-shaped cavity 11, however other shapes are possible in alternative embodiments. The side walls 184 may be shorter than the end walls 182. The end walls 182 may be oriented horizontally and the side walls 184 may be oriented vertically in an exemplary arrangement, however the backshell 10 is not limited to such an arrangement. The backshell 10 may include other walls 180 in addition to, or in the alternative to, the end and side walls 182, 184. In an exemplary embodiment, both the upper shell 34 and the lower shell 36 include side wall portions that define the side walls 184. The side walls 184 are integrally formed with corresponding end walls 182. Because the backshell 10 is manufactured from metal, the backshell 10 provides shielding for the cable connectors 6 and the individual cables 38 (shown in FIG. 2) extending through the cable exit plate 8 that form the cables 174.

The walls 180 extend axially between a front end 186 and a rear end 188. The end walls 182 include housing tabs 190 extending inward therefrom. The housing tabs 190 are configured to be received in the grooves 172 of the housing 12 to secure the backshell 10 to the housing 12. The end walls 182 include contact module tabs 192 extending inward therefrom. The contact module tabs 192 are configured to be received in corresponding grooves 170 of the contact modules 30 to secure the backshell 10 to the contact modules 30. The end wall 180 includes one or more wings 194 extending inward therefrom. The wings 194 are configured to engage the rear end 106 of the contact modules 30 when the backshell 10 is coupled to the contact modules 30. The wings 194 are configured to block rearward movement of the contact modules 30 with respect to the housing 12 by functioning as a rearward stop for the contact modules 30. As such, the wings 194 provide strain relief for the contact modules 30.

Rearward of the wings 194, the walls 180 include fingers 200. The fingers 200 are generally positioned rearward of the contact modules 30 and are to be aligned with the cable exit plate 8. Optionally, each of the walls 180 may include fingers 200. The fingers 200 engage the cable exit plate 8 to electrically common the backshell 10 and the cable exit plate 8. Multiple fingers 200 are provided such that the backshell 10 has multiple contact points to the cable exit plate 8. The fingers 200 are integrally formed with the backshell 10 and, in an exemplary embodiment, are formed during a stamping process. During the stamping process, slots 202 are formed in the walls 180 which allow the fingers 200 to move relative to the walls 180. The fingers 200 are cantilevered beams that extend from fixed ends 204 to distal ends 206. The distal ends 206 are movable with respect to the walls 180. The fingers 200 are non-planar with the walls 180. For example, during a forming process, the fingers 200 are bent into an arc shape such that the fingers 200 are convex and external to the cavity 11. The fingers 200 are cantilevered from the walls 180 and are initially angled outward and then angled back inward. In an exemplary embodiment, the distal ends 206 are positioned beneath the corresponding walls 180, and thus interior of the cavity 11.

The fingers 200 extend axially along the backshell 10 and have an apex 208 along the arc that is configured to engage a grounded component of the electronic device in which the receptacle connector assembly 4 is mounted. The grounded component may be a chassis, shell, housing, panel, frame or other like component, to which the receptacle connector assembly 4 is mounted. The grounded component is connected to a circuit ground, and may be connected to earth ground. By connecting to the grounded component, the backshell 10 may be electrically commoned to the grounded component.

In the illustrated embodiment, a polarizing feature 220 is mounted to the end wall 182 of the upper shell 34. The polarizing feature 220 orients the receptacle connector assembly 4 within the electronic device in which the receptacle connector assembly 4 is mounted. For example, the receptacle connector assembly 4 may be mounted within a computer or a network component. The polarizing feature 220 engages a corresponding feature of the electronic device to properly position the receptacle connector assembly 4. The polarizing feature 220 is secured to the backshell 10 using fasteners 222. Optionally, the fasteners 222 may also be coupled to the cable exit plate 8. In the illustrated embodiment, potting material may fill or substantially fill the area between the cable exit plate 8 and the cable connectors 6.

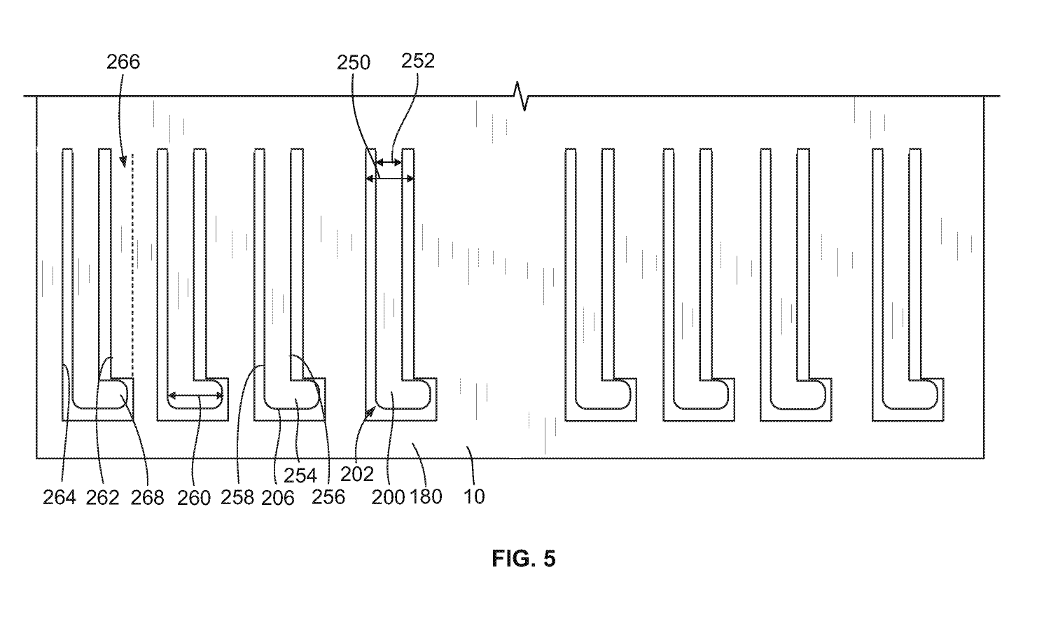

FIG. 5 is a top view of a portion of the backshell 10 illustrating the fingers 200. The fingers 200 are illustrated in a flattened state, wherein the fingers 200 do not have an arc shape, but rather are planar with the wall 180. The fingers 200 are in the flattened state after the fingers 200 are stamped and prior to being formed or bent into the convex shape. The fingers 200 may be forced to the flattened state from the formed state (shown in FIG. 1) during mating with the grounded component. For example, when the receptacle connector assembly 4 (shown in FIG. 1) is mounted to the grounded component of the electronic device, the fingers 200 are deflected downward and substantially flattened out. The fingers 200 may have a slight bow to ensure that the fingers 200 engage the grounded component.

The slots 202 are aligned with the fingers 200. In an exemplary embodiment, the slots 202 are formed during the stamping process when the fingers 200 are stamped from the wall 180. The slots 202 have a width 250 and the fingers 200 have a width 252 that is less than the width 250.

In an exemplary embodiment, the fingers 200 include tabs 254 proximate to the distal ends 206. Optionally, the tabs 254 may be provided at the distal ends 206. Alternatively, the tabs 254 may be provided near the distal ends 206 with a portion of the fingers 200 extending beyond the tabs 254. The tabs 254 project outward from one or both sides 256, 258 of the fingers 200. In the illustrated embodiment, the tabs 254 extend outward from the side 256, forming an L-shaped finger. Alternatively, the tabs 254 may extend outward from both sides 256, 258, forming a T-shaped finger. Because the finger 200 is stamped from the wall 180, the slot 202 has a shape that corresponds to the shape of the finger 200. The tabs 254 have a width 260 that is wider than the width 250 of the slots 202.

Each slot 202 has a first edge 262 and a second edge 264 on opposite sides of the slot 202. The wall 180 forms a ledge 266 at the first edge 262. A similar ledge may be formed at the second edge 264. During use, the tabs 254 are configured to be captured beneath the corresponding ledges 266. For example, an end 268 of each tab 254 is aligned with the ledge 266 and is captured beneath the ledge 266.

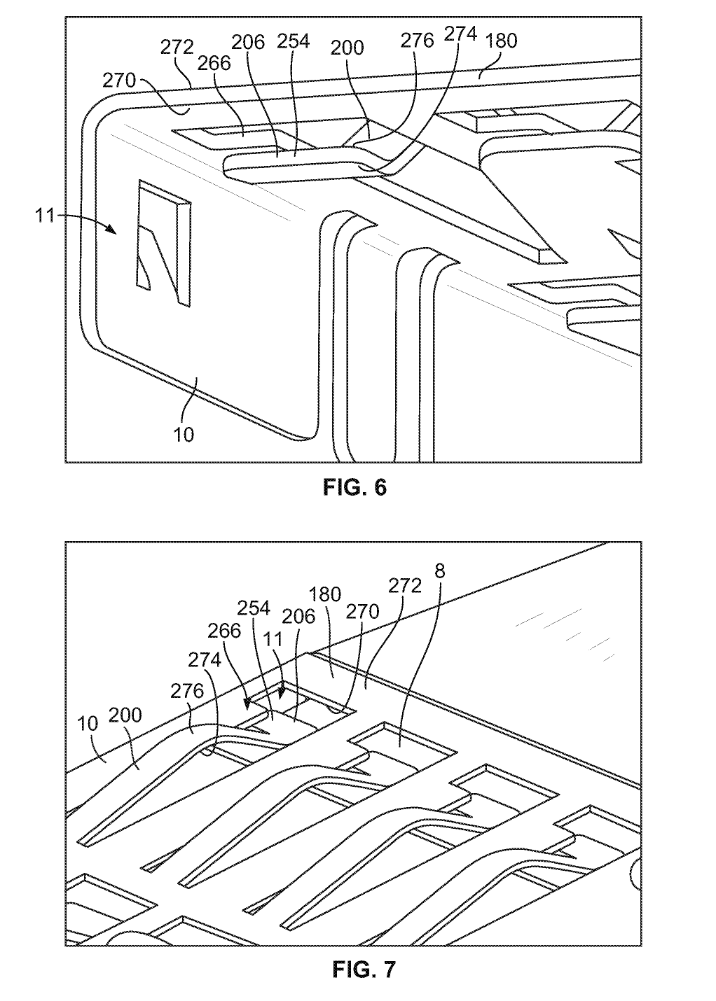

FIGS. 6 and 7 are bottom and top perspective views, respectively, of a portion of the backshell 10. The fingers 200 are bowed into the convex shape such that a majority of the fingers 200 are exterior of the cavity 11 (a portion of the cavity 11 is shown in FIGS. 6 and 7). The distal ends 206 are captured interior of the cavity 11 by the wall 180. The walls 180 have inner surfaces 270 facing the cavity 11 and outer surfaces 272 facing away from the cavity 11. The fingers 200 have inner surfaces 274 facing the cavity 11 and outer surfaces 276 facing away from the cavity 11. The inner surfaces 274 of the distal ends 206 are configured to engage the cable exit plate 8 (shown in FIG. 7) when the receptacle connector assembly 4 is assembled. The inner surfaces 274 of the distal ends 206 define multiple contact points for the backshell 10 for making an electrical connection with the cable exit plate 8.

When the fingers 200 are formed and given the arc shape, the effective length of the fingers 200 is reduced, which draws the tabs 254 beneath the wall 180, such as beneath the corresponding ledges 266. The outer surfaces 276 of the fingers 200 at the distal ends 206 engage the inner surface 270 of the corresponding wall 180. For example, the outer surfaces 276 may engage the inner surfaces 270 of the corresponding ledges 266. As such, the distal ends 206 of the fingers 200 are protected from damage. For example, the distal ends 206 are less susceptible to snagging or stubbing as the distal ends 206 are held in place and not exposed external to the backshell 10. Having the tabs 254 formed integral with the fingers 200 reduces part count and allows the backshell to be made reliably and economically.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A connector assembly comprising:
a connector having a connector housing holding contacts, the contacts being configured to be terminated to cables extending rearward from the connector housing; and
a backshell having walls defining a cavity receiving the connector housing and cables, the backshell being electrically connected to cable shields of the cables, the backshell having fingers extending from the walls, the fingers being configured to engage a grounded component exterior of the cavity, distal ends of the fingers being captured interior of the cavity.

2. The connector assembly of claim 1, wherein the walls have slots aligned with the fingers, the fingers having tabs proximate to the distal ends of the fingers, the tabs being loaded through the slots and being captured by the corresponding wall interior of the cavity.

3. The connector assembly of claim 1, wherein the fingers have fixed ends opposite the distal ends, the fingers being arc shaped between the fixed ends and the distal ends with a majority of each finger being exterior of the cavity and with the distal ends interior of the cavity.

4. The connector assembly of claim 1, wherein the walls have inner surfaces facing the cavity and outer surfaces facing away from the cavity, the fingers having inner surfaces facing the cavity and outer surfaces facing away from the cavity, the outer surfaces of the fingers at the distal ends engaging the inner surfaces of the corresponding walls.

5. The connector assembly of claim 1, wherein the walls have slots aligned with the fingers, the slots are defined by edges, the distal ends being captured beneath corresponding edges of the slots.

6. The connector assembly of claim 1, further comprising a cable exit plate configured to engage, and be electrically connected to, the cable shields, the distal ends of the fingers engaging the cable exit plate and being captured between the cable exit plate and the corresponding wall.

7. The connector assembly of claim 1, wherein the walls form a parallelepiped cavity, each of the walls having fingers.

8. The connector assembly of claim 1, wherein the fingers have tabs at the distal ends, the fingers having a first width, the tabs having a second width wider than the first width.

9. The connector assembly of claim 1, wherein the walls are stamped to form the fingers with slots surrounding the fingers, the walls having a ledge flanking each slot, the distal ends being captured interior of the cavity by the corresponding ledge.

10. A connector assembly comprising:
a connector having a connector housing holding contacts, the contacts being configured to be terminated to cables extending rearward from the connector housing; and
a backshell having walls defining a cavity receiving the connector housing and cables, the backshell being electrically connected to cable shields of the cables, at least one of the walls having fingers extending therefrom and slots aligned with the fingers, the fingers being configured to engage a grounded component exterior of the cavity, the fingers having tabs proximate to distal ends of the fingers, the tabs being loaded through the slots and being captured by the corresponding wall interior of the cavity.

11. The connector assembly of claim 10, wherein the fingers have fixed ends opposite the distal ends, the fingers being arc shaped between the fixed ends and the distal ends with a majority of each finger being exterior of the cavity and with the distal ends interior of the cavity.

12. The connector assembly of claim 10, wherein the walls have inner surfaces facing the cavity and outer surfaces facing away from the cavity, the fingers having inner surfaces facing the cavity and outer surfaces facing away from the cavity, the outer surfaces of the fingers at the tabs engaging the inner surfaces of the corresponding walls.

13. The connector assembly of claim 10, wherein the walls have a ledge flanking each slot, the distal ends being captured interior of the cavity by the corresponding ledge.

14. The connector assembly of claim 10, further comprising a cable exit plate configured to engage, and be electrically connected to, the cable shields, the distal ends of the fingers engaging the cable exit plate and being captured between the cable exit plate and the corresponding wall.

15. The connector assembly of claim 10, wherein the slots have a first width and the tabs have a second width wider than the first width, the tabs being aligned with the slots such that the tabs engage the wall adjacent the corresponding slots.

16. A backshell for a connector assembly, the backshell comprising:
walls defining a cavity configured to receive a cable, the walls being configured to be electrically connected to a cable shield of the cable;
fingers being cantilevered from at least one of the walls, the fingers being configured to engage a grounded component exterior of the cavity, distal ends of the fingers being captured by the corresponding wall interior of the cavity.

17. The backshell of claim 16, wherein the walls have slots aligned with the fingers, the fingers having tabs proximate to distal ends of the fingers, the tabs being loaded through the slots and being captured by the corresponding wall interior of the cavity.

18. The backshell of claim 16, wherein the fingers have fixed ends opposite the distal ends, the fingers being arc shaped between the fixed ends and the distal ends with a majority of each finger being exterior of the cavity and with the distal ends interior of the cavity.

19. The backshell of claim 16, wherein the walls have inner surfaces facing the cavity and outer surfaces facing away from the cavity, the fingers having inner surfaces facing the cavity and outer surfaces facing away from the cavity, the outer surfaces of the fingers at the tabs engaging the inner surfaces of the corresponding walls.

20. The backshell of claim 16, wherein the walls have a ledge flanking each slot, the distal ends being captured interior of the cavity by the corresponding ledge.
